(19) United States
(12) Patent Application Publication
(10) Pub. No.: US 2022/0236739 A1
(43) Pub. Date: Jul. 28, 2022

(54) SYSTEM AND METHOD FOR OPTICAL LOCALIZATION

(71) Applicant: Advanced Intelligent Systems Inc., Bumaby (CA)

(72) Inventors: Farhang Bidram, Burnaby (CA); Michael Wrock, Burnaby (CA); Salar Asayesh, Burnaby (CA); Keith Chow, Burnaby (CA); Shahram Pourazadi, Burnaby (CA); Amirmasoud Ghasemi Toudeshki, Burnaby (CA); Mohammad Yavari, Burnaby (CA)

(21) Appl. No.: 17/621,859

(22) PCT Filed: Jun. 29, 2020
(86) PCT No.: PCT/CA2020/050903

§ 371 Date: Dec. 22, 2021

Related U.S. Application Data
(60) Provisional application No. 62/868,726, filed on Jun. 28, 2019.
(60) Provisional application No. 62/939,130, filed on Nov. 22, 2019.

(51) Int. Cl. G05D 1/02; B25J 5/00; G05D 1/00

(52) U.S. Cl. CPC G05D 1/0234; G05D 1/0094; B25J 5/007

(57) ABSTRACT

A system and method for optical localization of an autonomous mobile robot. The system includes a number of movable stationary landmarks defining an operating space for the robot. The robot includes a self-propelled mobile chassis, an optical sensor (a LiDAR sensor or optical camera) disposed on a raised portion and configured to detect the landmarks, and a controller configured to determine the position and orientation of the chassis based on information from the optical sensor. The landmarks have an elevated portion extending vertically to a height level which is equal to or higher than the horizontal plane of the optical sensor. Each landmark may have a cross-sectional feature and/or a visually distinct portion, to enable determining the orientation (of the optical sensor/mobile robot) relative to the landmark; as well as an identifier for uniquely identifying the landmark from others.

### TECHNICAL FIELD

The present disclosure relates to autonomous mobile robots, particularly a localization system for mobile robots using optical devices.

### BACKGROUND

Robotic vehicles may be configured for autonomous or semi-autonomous operation for a wide range of applications including product transportation, material handling, security, and military missions. Autonomous mobile robotic vehicles typically have the ability to navigate and to detect objects automatically and may be used alongside human workers, thereby potentially reducing the cost and time required to complete otherwise inefficient operations such as basic labor, transportation and maintenance. An important part of robotic autonomy is robot's ability to reliably navigate within a workspace. Numerous positioning system approaches are known that attempt to provide accurate mobile robot positioning and navigation without the use of GPS. Some autonomous vehicles track movement of driven wheels of the vehicle using encoders to determine a position of the vehicle within a workspace. Other autonomous vehicles use other approaches such as GPS-pseudolite transmitters, RF beacons, ultrasonic positioning, active beam scanning and landmark navigation.

In particular, a landmark navigation system uses a sensor, usually a camera, to determine a vehicle's position and orientation with respect to artificial or natural landmarks. Artificial landmarks may be deployed at known locations and certain systems contemplate artificial landmarks that involve the use of a high contrast bar code or dot pattern. A sensor device can observe both the orientation and distance relative to the landmark, so that only two landmarks need to be viewed in order to compute the vehicle's position. The challenge in a landmark navigation system is in reliably identifying the landmarks in cluttered scenes. The accuracy of the position computation is dependent on accurately determining the camera orientation to the landmark. Also, sufficient illumination is necessary with existing landmark navigation solutions.

Nevertheless, landmark navigation is attractive because of its potential for accuracy, high reliability, low cost and relative ease of deployment. There is, therefore, a need for an improved landmark navigation positioning system that can achieve the reliability and accuracy that current positioning system solutions for robotic or unmanned vehicles cannot.

The proposed optical system of localization for mobile robots can provide additional accuracy and reliability over existing methods of localization (such as those relying on Ultra Wideband (“UWB”) localization), and additionally can potentially use the same sensors for obstacle detection and avoidance, for example.

### SUMMARY

In accordance with one disclosed aspect, there is provided a system for optical localization. The system includes a plurality of movable stationary landmarks defining an operating space and an autonomous mobile robot located in and operating within the operating space. The mobile robot includes a self-propelled mobile chassis, an optical sensor assembly disposed on a raised portion vertically spaced apart from the chassis and configured to detect at least one of the plurality of landmarks, and a controller configured to determine the position and orientation of the chassis based at least on information from the optical sensor assembly. The optical sensor assembly may include a LiDAR sensor or an optical camera. Each landmark of the plurality of landmarks may be in the form of a structure having an elevated portion extending vertically from the ground surface to a height level which is equal to or higher than a horizontal plane parallel to the surface and extending from the optical sensor assembly of the mobile robot, wherein the elevated portion is optically detectable by the optical sensor assembly. Each landmark of the plurality of landmarks may have one or more of: a characteristic cross-sectional feature for determining orientation (of the optical sensor assembly/mobile robot) relative to the landmark; a characteristic visually distinct portion for determining orientation (of the optical sensor assembly/mobile robot) relative to the landmark; and an identifier uniquely identifying the landmark from other landmarks. The optical sensor assembly may be mounted on an actuated column vertically movable between an extended portion where the optical sensor assembly is vertically spaced apart from the chassis and a retracted position where the optical sensor assembly is held relatively near the ground.

In accordance with another disclosed aspect, there is provided a method for optical sensor-based localization of an autonomous mobile robot. The method involves detecting, by an optical sensor assembly, an optical reference, determining, by a processing unit, based on the detected optical reference—a distance to the optical reference, a relative angle to the optical reference, and an orientation of the optical reference; and calculating, by the processing unit, the orientation and position of the mobile robot based on the detected distance, orientation, and relative angle of the optical reference using a known relationship between the mobile robot, the optical sensor assembly, and the detected optical reference. The method may further include moving the optical reference, while keeping the optical sensor assembly stationary or moving the optical sensor assembly, while keeping the optical reference stationary; tracking, by the processing unit, the relative movement of the optical reference to the optical sensor assembly and information regarding which of the optical reference or optical sensor assembly was moved, and determining, by the processing unit, a new position and orientation of the mobile robot based on the detected distance and relative angle of the optical reference using a known relationship between the mobile robot, the optical sensor assembly, and the detected optical reference, the tracked relative movement of the optical reference the sensor assembly, and the information regarding which of them was moved. The known relationship may be either a static relationship defined at initialization, or a dynamic relationship which may change during operation and be communicated to the processing unit.

In accordance with a further disclosed aspect, there is provided a method for optical sensor-based localization of an autonomous mobile robot during operation. The method involves detecting, by an optical sensor assembly of a mobile robot located at a first position, a first optical reference and a second optical reference, determining, by a processor, based on the detected optical references—a distance to each optical reference, and a relative angle to each of the detected optical references; calculating, by the processor, the orientation and position of the mobile robot based on the detected distances and relative angles of the optical references, detecting, by the optical sensor assembly, further optical references, calculating, by the processor, the position of each further optical reference with respect to the first and second optical references, moving, by the mobile robot, from the first position to a second position, detecting, by the optical sensor assembly, at least two previously detected optical references, and calculating, by the processor, the orientation and position of the mobile robot based on the detected distances and relative angles of any two of the detected optical references.

The method may further involve establishing, by the processor, a global coordinate system based on the detected optical references. The method may then include detecting, by a second sensor of the mobile robot, one or more objects, calculating, by the processor, the position of each of the detected objects with respect to the optical references by—determining, by the processor, the relative position of the second sensor to the mobile robot, determining, by the second sensor, the position of each object relative to the robot, and transforming, by the processor, the position of each object relative to the second sensor to the global coordinate system; and storing, by the processor, the calculated positions with respect to the global coordinate system in a memory. The method may also involve storing, by the processor, the relative positions of each of the detected optical references in a memory, and determining, by the processor, the identity of features detected by the optical sensor assembly as optical references based on at least the stored relative positions of the optical references stored in the memory. The method may additionally involve detecting, by the optical sensor assembly, an optical feature of a second mobile robot, determining, by the processor, based on the detected optical feature one or more of a distance to the second mobile robot and an orientation of the second mobile robot, calculating, by the processor, the orientation and position of the second mobile robot relative to the optical references based on the detected distances and relative angles of the optical feature, and maintaining, by the mobile robot, a minimum distance of separation to the second mobile robot. The method may then also involve communicating, by the processor of the mobile robot through a communication device on the mobile robot, with the processor of the second mobile robot through a communication device on the second mobile robot, and transmitting, by the processor of the mobile robot, the orientation and position of the second mobile robot relative to the optical references.

In accordance with yet another disclosed aspect, there is provided a method for initializing a system for optical localization of an autonomous mobile robot. The method involves placing at least three optical references, the placement of the optical references forming a predetermined angle, concealing two optical references defining a width of an operating space from an optical sensor assembly of a mobile robot, detecting, by the optical sensor assembly, an environment of the operating space, unmasking the two optical references to the optical sensor assembly and detecting, by the optical sensor assembly, the two optical references, and determining, by a processor of the mobile robot, the width of the operating space based on the distance between the two detected unmasked optical references. The method then involves rotating, by the mobile robot, searching for and detecting, by the optical sensor assembly, the third optical reference, selected based on the relative angle of the location of the third reference with respect to the line formed by the two detected unmasked optical references, and defining, by the processor of the mobile robot, the length of the operating space as a perpendicular distance between the detected third optical reference and the line formed by the two detected unmasked optical references.

In accordance with another aspect, also disclosed herein is a method for expanding an operation space of a mobile robot. This method includes determining, by a processing unit, that the mobile robot has completed a work task in the operating space followed by assigning, by the processing unit, a relocation task to the mobile robot, the relocation task comprising moving one or more landmarks of a plurality of landmarks from a first position of each of the one of more landmarks to a second position of each of the one or more landmarks. The method then includes executing, by the mobile robot, the relocation task, the task involving navigating, by the mobile robot, to a first landmark of the one or more landmarks located at a first position using the disclosed optical localization system comprising the plurality of landmarks, transporting, by the mobile robot, the first landmark to a second position for the landmark, comprising navigating using the optical localization system, and repeating from the navigating step for each other landmark of the one or more landmarks to be moved. The method then includes assigning, by the processing unit, a new work task to the mobile robot in the operating space defined by new landmark positions. In this manner, once the work task (e.g. a method of transportation of articles) has been completed for one operating space, the mobile robot can automatically define a new operating space, and perform the work task in the new operating space, without requiring human intervention.

### BRIEF DESCRIPTION OF THE DRAWINGS

In the following, embodiments of the present disclosure will be described with reference to the appended drawings. However, various embodiments of the present disclosure are not limited to arrangements shown in the drawings.

FIG. 1 is a plan view of a system for optical localization.

FIG. 2 is a perspective view of an embodiment of an autonomous mobile robot using the system for optical localization of FIG. 1.

FIG. 3 is a perspective view of an embodiment of a landmark used in the system for optical localization of FIG. 1.

FIG. 4 is a side view of an alternative embodiment of an autonomous mobile robot using the system for optical localization of FIG. 1.

FIG. 5 is a block diagram view of a method for optical localization.

FIG. 6 is a block diagram view of an alternative method for optical localization.

FIG. 7 is a plan view of a system implementing a method of optical localization.

FIG. 8 is a block diagram view of a method of initializing a system for optical localization.

FIG. 9 is a schematic plan view illustrating a system implementing a method for expanding the operating space of a mobile robot.

FIGS. 10A and 10B are schematic plan views of an alternative embodiment of a system implementing a method for expanding the operating space of a mobile robot.

FIG. 11 is a perspective view of an alternative embodiment of a landmark operable with the disclosed system.

FIG. 12 is a block diagram illustrating a method for expanding the operating space of a mobile robot.

### DETAILED DESCRIPTION

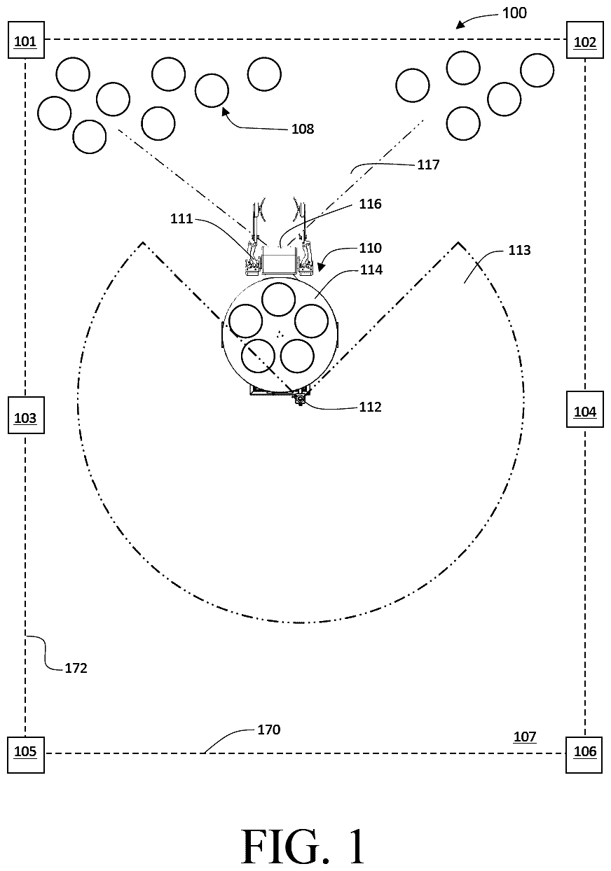

Referring to FIG. 1, a system for optical localization of an autonomous mobile robot is shown generally at 100. The system 100 includes a plurality of movable stationary landmarks 101, 102, 103, 104, 105, and 106 defining a work field 107. The work field 107 is defined by defining a base line 170 and a field boundary 172. The base line 170 may define the start and end positions for moving work for example, and provides a reference line for an axis for an x-y coordinate system, for example, in which a mobile robot is being localized. The field boundary 172 determines the area a mobile robot 110 may freely move in. The work field 107 may be defined at initialization in a variety of ways—for example, the mobile robot 100 may be provided the dimensions of the work field 107 by an operator and the size of work field 107 is defined by these parameters, the robot 110 using odometry to stay within the boundaries and only using landmarks 101, 102, 103, 104, 105, 106 to correct odometry drift. In another example, the work field 107 may be defined by providing the robot 110 with configuration information regarding the system such as the landmarks 101 and 102 defining one end of the work field 107 and the landmarks 105 and 106 defining the opposite end, with the base line 107 defined as the line between landmarks 105 and 106, and the field boundary between landmarks 101 and 105, running through landmark 103 as well as between landmarks 102 and 106 running through landmark 104. In yet another example, the robot 110 may be provided with configuration information that the work field 107 is defined by three pairs of landmarks, with the base line 170 defined by the line running through third pair of landmarks (in this case landmarks 105 and 106), and the field boundary running through the landmark of each pair on the same side. The system 100 may additionally include a plurality of articles 108 (such as plant pots being transported by the mobile robot) located in the work field 107. The system 100 includes the autonomous mobile robot 110 also located in the work field.

The robot 110 includes a raised optical sensor 112 (sometimes also referred to herein as an optical sensor assembly) mounted on a raised portion of the robot 110 and having a field of view 113, and may include a manipulator 111 for interacting with articles 108. The robot 110 may also include a storage space 114 for storing articles, and a second optical sensor 116 mounted on the robot 110 and having a different field of view from the elevated optical sensor 112, such as the complementary field of view 117 shown in FIG. 1. The field of view 113 of the raised optical sensor 112 is preferably around 270 degrees or greater, allowing the sensor 112 to see two or more of the stationary landmarks 101, 102, 103, 104, 105, and 106 at any given time. For example, in FIG. 1, landmarks 103, 104, 105 and 106 are within the field of view 113. For a work field 107 of a different size, there may be additional landmarks which extend along the lines formed by landmarks 101, 103, 105 and by landmarks 102, 104, 106, for example.

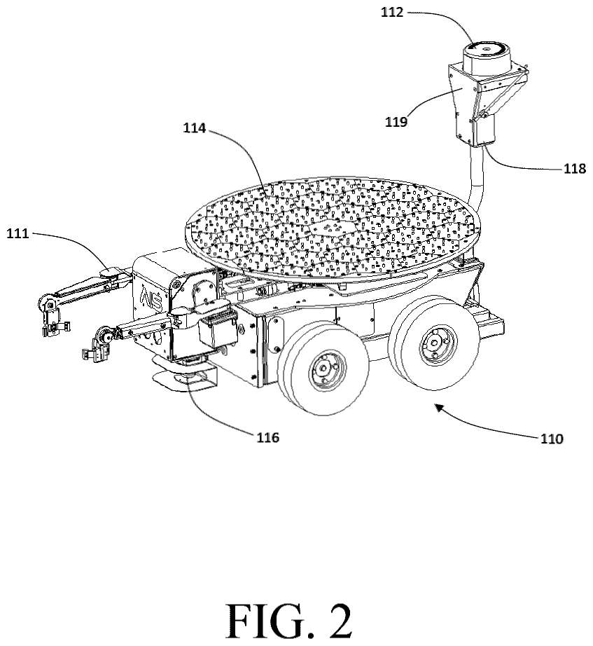

Referring to FIG. 2, an embodiment of the mobile robot 110 of FIG. 1 is shown in greater detail. In other embodiments the mobile robot may be unmanned aerial vehicles or other unmanned ground vehicles or any other mobile robot. The raised optical sensor 112 can be seen attached to the top of a tower structure 118 of the mobile robot 110. The tower structure 118 may additionally house additional components, such as a communication system 119 allowing the mobile robot 110 to communicate over a wireless network, for example. If present as in the depicted embodiment, the second sensor 116 may be mounted at a different elevation on the mobile robot 110 than the raised optical sensor 112, and may be useful in detecting obstacles at different heights, or for detecting objects such as articles 108 while the plane of view of the raised optical sensor 112 goes over such objects. Each of sensors 112 and 116 may be a Light Detection and Ranging (LiDAR) sensor, an optical camera, or a combination of the two. Both sensors 112 and 116 may also be used for other purposes, such as pathfinding, object avoidance, safety, and data gathering for example.

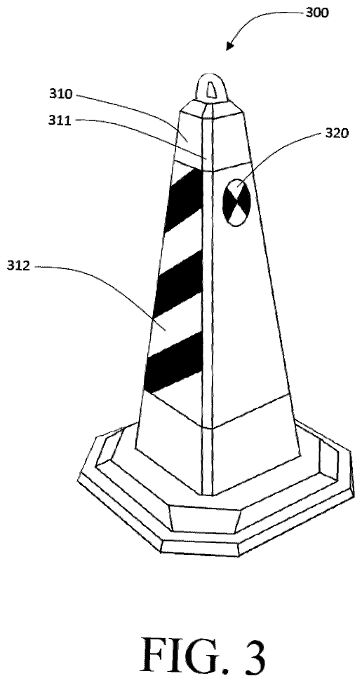

Referring to FIG. 3, an embodiment of a movable stationary landmark such as landmarks 101, 102, 103, 104, 105 or 106 of FIG. 1 is shown generally as 300. The landmark 300 includes an elevated portion 310, which extends vertically so that the raised optical sensor 112 retains line of sight to the elevated portion 310 even if intervening objects are on the surface between the robot 110 and the landmark 300. The elevated portion 310 generally extends at least to a height level which is equal or higher than a horizontal plane parallel to the surface extending from the raised optical sensor 112. The elevated portion 310 may have a characteristic cross-sectional geometry feature 311 so that a LiDAR or other optical sensor operating at the horizontal plane parallel to the surface extending from the raised optical sensor 112 can distinguish the landmark 300 from other objects having a cross-section at that plane. The characteristic feature 311 may additionally provide information on the relative angle of the detecting sensor 112 to the landmark 300, such as in this case being a feature (the chamfered edge) that exists only on a single edge of the cone, meaning for a given known orientation of the landmark 300, the relative angle to the landmark can be determined by finding the chamfered edge, for example. The landmark 300 may additionally include a visually distinct portion 312, such as a striped face. The striped face may contain material with different (enhanced) reflectivity compared to the rest of the landmark and the surrounding environment, for example, to produce a distinct increase in reflective intensity in a particular wavelength—under either or both of optical lighting and LiDAR. The visually distinct portion 312 serves a similar purpose as the characteristic feature 311, for either or both of an optical camera version of sensor 112 or the LiDAR version of sensor 112. The visually distinct portion 312 may assist the processing algorithm of the sensor 112 in distinguishing the landmark 300 from background objects. Similarly, the visually distinct portion 312 may additionally provide information on the relative angle of the detecting sensor 112 to the landmark 300, since like the characteristic feature 311, the portion 312 may exist only on one face of the landmark 300, and the relative angle to the landmark can be determined by finding the striped face, for example. Aspects of landmark 300 such as feature 311 or portion 312 may also be used to supplement other methods of determining the orientation of robot 110, such as an Inertial Measurement Unit (IMU), odometry, global mapping, or any other orientation determination method. The landmark 300 also includes a unique identifier 320. The unique identifier 320 is a feature of landmark 300 which uniquely identifies it from other instances of landmark 300, such as uniquely identifying landmark 101 from 102, for example. The identifier 320 is shown in FIG. 3 as a circle with a pattern, but may be any other type of identifier, such as an alphanumeric character, a color, a shape, a pattern, a QR code, any combination of the above or any other method of uniquely identifying the landmark 300 detectable by the optical sensor 112. Uniquely identifying the landmark 300 allows the system a further method of determining the orientation of the mobile robot 110, and also allows for an additional method in determining absolute positioning which may improve accuracy.

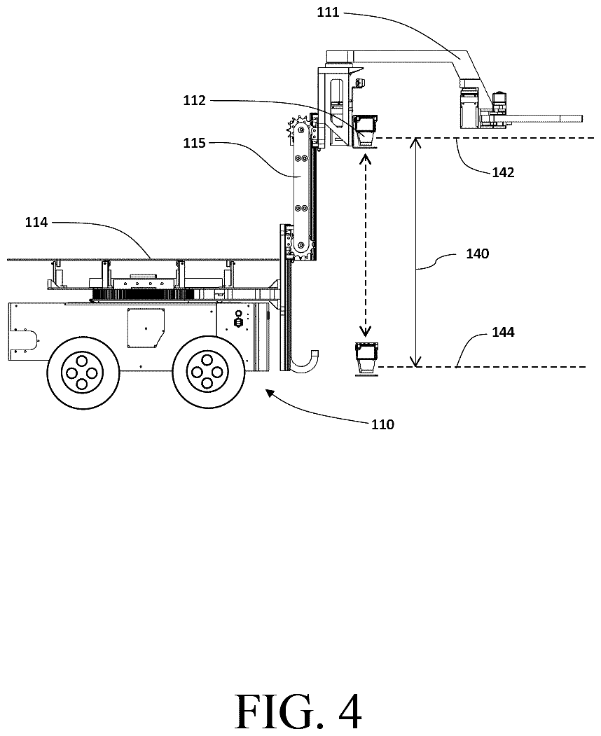

Referring to FIG. 4, an alternative embodiment of mobile robot 110 of FIG. 1 is shown. In this embodiment, the manipulator 111 is a Selective Compliance Assembly Robot Arm (SCARA) manipulator, and the optical sensor 112 is attached to telescoping column 115 of the manipulator 111. The telescoping column 115 is extendable and collapsible along a range of heights 140, moving the optical sensor 112 between a raised position 142 and a lowered position 144, along with an end effector of manipulator 111. In this embodiment, when the optical sensor 112 is in the raised position 142, it has sufficient height to clear the articles 108 in the work field 107, allowing the optical sensor 112 to detect landmarks 101-106, for example. Conversely, when the optical sensor 112 is in the lowered position 144, it can act as the second optical sensor 116 of FIG. 2, providing an alternative elevation more suitable for detecting obstacles near the ground such as articles 108. As the robot 110 does not necessarily require continuous uninterrupted detection of either landmarks 101-106 or articles 108 for effective navigation, the optical sensor 112 can be raised and lowered according to the navigational needs of robot 110. For example, when the robot 110 is manipulating articles 108, the robot 110 is likely to be stationary, and the optical sensor 112 can be directed to detecting articles 108 in the lowered position 144, the robot 110 remembering its localization from when the landmarks 101-106 were last detected. Conversely, when the robot 110 is moving long distances, the robot 110 can remember the location of articles 108 and navigate with the optical sensor 112 in the raised position 142 to maintain line of sight on landmarks 101-106 for accurate localization. In combination with stored memory, a height adjustable optical sensor 112 can effectively replace the second optical sensor 116 in certain applications, reducing the cost and complexity of the robot 110.

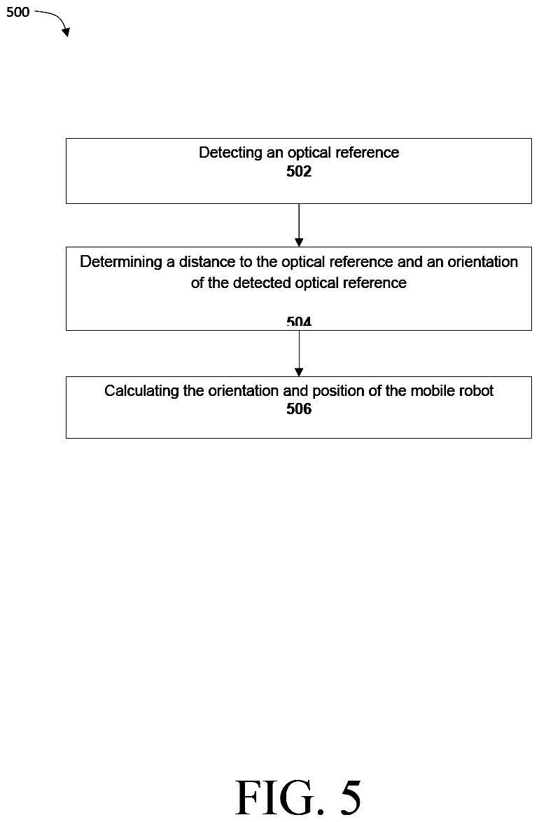

Referring to FIG. 5, a method for optical sensor-based localization of an autonomous mobile robot is shown generally at 500. The method 500 includes a detecting step 502 followed by a determination step 504 and finally a calculating step 506. In the detecting step 502, an optical sensor assembly detects an optical reference. The optical sensor assembly may be a sensor assembly disposed on the autonomous mobile robot, detecting the optical reference. The optical reference in this case may be a static, passive, stationary landmark, or the optical reference may be a mobile landmark such as another mobile robot capable of self-relocation, for example. Alternatively, the optical sensor assembly may be external to the mobile robot, and the optical reference may be one or more features of the mobile robot itself which can be detected by the external optical sensor assembly. The optical sensor assembly in this case may be attached to a stationary object such as a tower, or may be disposed on a mobile base, such as another mobile robot, for example. In either case, at least one of the optical sensor assembly or the optical reference should remain stationary to provide a fixed reference point for the other. in the determination step 504, a processing unit determines, based on the detected optical reference, a distance to the optical reference, a relative angle to the optical reference, and an orientation of the optical reference. The distance to and the relative angle to the optical reference may be acquired through the detection process itself, such as with a LiDAR sensor which can simultaneously acquire both sets of information from operation. In alternative systems, such as using an optical camera, the distance to the reference may be determined using methods such as stereoscopic triangulation, for example. The orientation of the optical reference may be determined using one or more optical features of the optical reference, such as through detecting multiple points of the optical reference and determining its orientation by calculating its facing based on the relative angle to each of the detected points, for example. The processing unit may be located on the mobile robot, or may be external to the mobile robot, being located for example on a stationary tower which may also have the optical sensor assembly, or the processing unit may be a local server or cloud server in communication with the mobile robot. The calculating step 506 involves calculating, by the processing unit, the orientation and position of the mobile robot based on the detected distance, orientation, and relative angle of the optical reference, as determined in determining step 504, using a known relationship between the mobile robot, the optical sensor assembly, and the detected optical reference. Examples of the known relationship may include the location of the optical sensor assembly with respect 10 to the mobile robot such as whether it is on the robot or external, or a particular detected geometry of the optical reference with respect to the mobile robot such as the position of the optical reference on the mobile robot if the reference is attached to the robot.

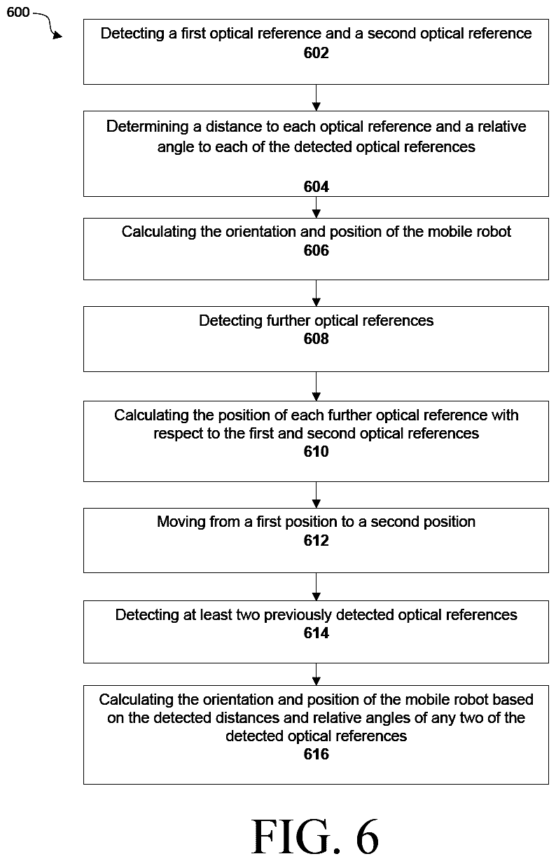

Referring to FIG. 6, a method for optical sensor-based localization of an autonomous mobile robot during operation is shown generally at 600. The method 600 includes a first detecting step 602, a determining step 604, a first calculating step 606, a second detecting step 608, a second calculating step 610, a moving step 612, a third detecting step 614, and a third calculating step. In the first detecting step 602, an optical sensor assembly disposed on the autonomous mobile robot located at a first position detects a first optical reference and a second optical reference. The first and second optical references may be special landmarks configured for the method for optical sensor-based localization, such as special cones (artificial landmarks) or self-propelled mobile robots (mobile landmarks), or may be a features natural to the environment (natural landmarks), which may be modified to increase detectability by the optical sensor assembly, for example. In the determining step, a processor determines based on the detected optical references a distance to each optical reference and a relative angle to each of the detected optical references. The distance to and the relative angle to the optical reference may be acquired through the detection process itself, such as with a LiDAR sensor which can simultaneously acquire both sets of information from operation. In alternative systems, such as using an optical camera, the distance to the reference may be determined using methods such as stereoscopic triangulation, for example. The first calculating step 606, involves calculating, by the processor, the initial orientation and position of the mobile robot based on the detected distances and relative angles of the optical references. The processor may calculate the distance and relative angle to the first optical reference and the distance and relative angle to the second optical reference, defining the line between the two optical references as one coordinate axis and/or the width of the operating space, and a line perpendicular to the two detected optical references as the orthogonal axis, then calculates the position of the mobile robot based on the coordinate axes, for example. The method 600 then involves detecting further optical references by the optical sensor assembly in the second detecting step 608 and calculating, by the processor, the position of each further optical reference with respect to the first and second optical references in the second calculating step 610. The processor may calculate the detected positions of the additional optical references based on the coordinate axes, for example, and one or more of the detected additional optical references may be used to define the lengthwise boundary of the operating space of the mobile robot, for example.

While the mobile robot is operating, the mobile robot will generally move from its initial position, the first position, to a second position, as in the moving step 612. During and after this process, the mobile robot needs to be continuously “localized”. The method 600 does so by continually detecting, as in the third detecting step 614, at least two of the previously detected optical references through the optical sensor assembly, allowing the processor to continue to accurately calculate the position and orientation of the mobile robot in the third calculating step 616 based on the detected distances and relative angles of the two detected optical references. The processor may keep track, in a memory, identities of each of the optical references such that the mobile robot remains localized in the coordinate axes, for example.

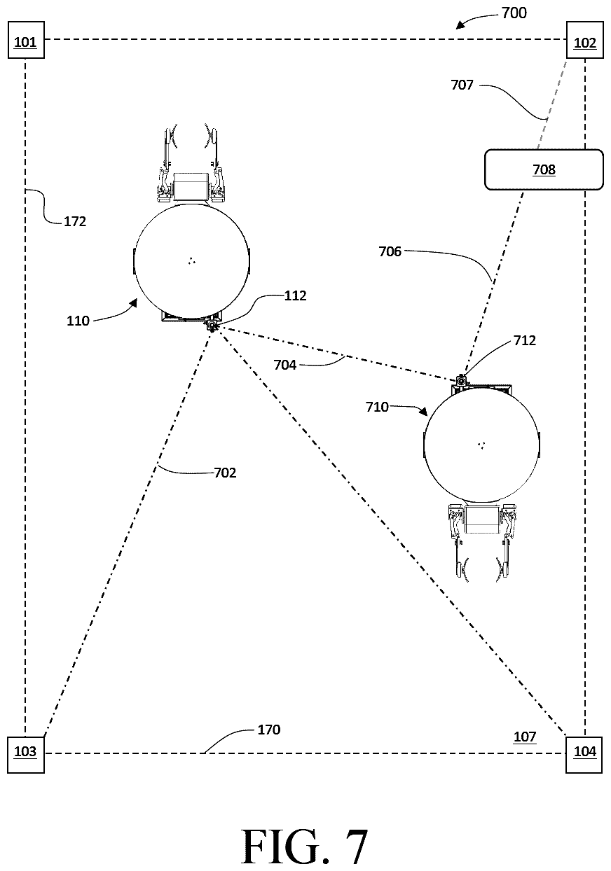

Referring to FIG. 7, a system implementing a method of optical localization is shown generally at 700. The system 700 includes a number of elements similar to system 100 described above with reference to FIG. 1, such as a plurality of movable stationary landmarks 101, 102, 103, and 104 defining a work field 107 with a base line 170 and boundary line 172 constraining the operating space of a mobile robot 110 with a mounted optical sensor assembly 112. In the system 700, however, there is a second mobile robot 710 with its corresponding optical sensor assembly 712. As shown in FIG. 7, the optical sensor assembly 112 of the first robot 110 may have two optical references 103 and 104 within its rearward-facing field of view (as shown in FIG. 1), as the sensor assembly 112 has direct line of sight 702 to each optical reference 103 and 104. Additionally, the optical sensor assembly 112 is able to detect the second mobile robot 710 shown in this case by detecting its optical sensor assembly 712 which is asymmetrical allowing the first robot 110 to determine both the position and orientation of the second robot 710, for example, but, in other embodiments, the first robot may be able to detect the second robot 710 through some other means such as detecting the second robot 710 with its second optical sensor assembly, or detecting the second robot 710 by detecting its manipulator, for example. However, the optical sensor assembly 712 of the second robot 710 is unable to detect two optical references (in this case, 101 and 102) with its rearward-facing field of view (as shown in FIG. 1), due to an obstacle 708 occluding line of sight 707 to the optical reference 102, the optical sensor assembly 712 only being able to detect the obstacle 708 with its line of sight 706 and not the optical reference 102. Being able to only detect one optical reference 101, the second robot 710 is unable to localize itself accurately. However, as the first robot 110 is able to detect two optical references 103 and 104, and can detect the second robot 710 through having line of sight 704, the first robot 110 can accurately localize the second robot 710, and can do so collaboratively by determining the position and orientation of the second robot 710 and communicating the information with the second robot 710. While, as shown in FIG. 7, the reason for the inability of the second robot 710 to localize itself is due to the presence of an obstacle 708, the described method of localizing the second robot 710 using the first robot 110 also applies to any other case where the second robot 710 cannot localize itself, but the first robot 110 can localize itself and can detect and determine the relative position and orientation of the second robot 710, such as when the second robot is too far from any optical reference, but the first robot 110 is within range. This can further be extrapolated to a third, fourth, etc. mobile robot allowing a chain of mobile robots to extend the radius of accurate localization without requiring additional landmarks, for example. Furthermore, this is applicable even if each mobile robot is itself moving, as long as one mobile robot can detect two stationary landmarks, allowing the chain or mobile robots to operate relatively far from stationary landmarks.

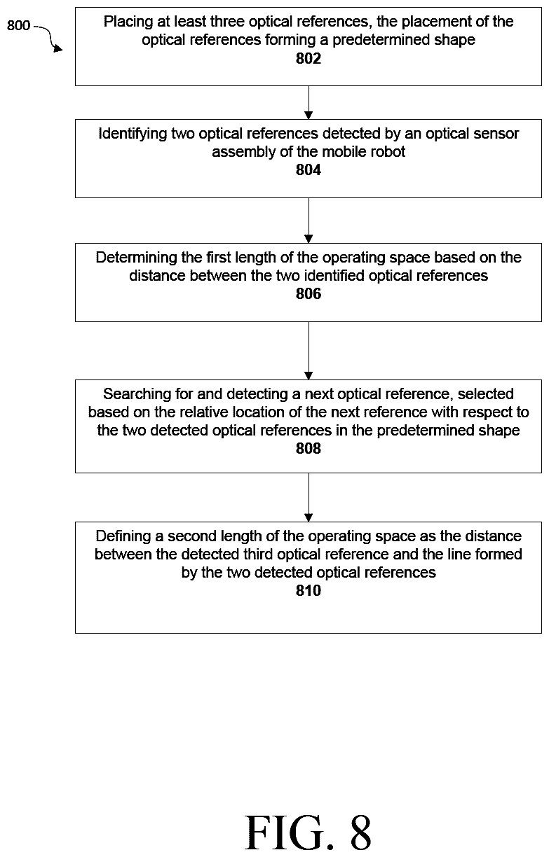

Referring to FIG. 8, a method for initializing a system for optical localization of an autonomous mobile robot is shown generally at 800. The method 800 includes a placing step 802, an identifying step 804, a determining step 806, a searching step 808 and a defining step 810. The placing step 802 involves placing at least three optical references. The three optical references are placed at a known predetermined angle, which is ideally approximately 90 degrees for a rectangular operating space, but may be any other angle. The identifying step 804 involves identifying, by a processor of the mobile robot, two optical references that are detected by an optical sensor assembly of the mobile robot.

The identifying step 804 may involve concealing the two optical references, the two concealed references defining a first length of an operating space, from an optical sensor assembly of a mobile robot, followed by detecting, by the optical sensor assembly, an environment of the operating space. These steps are done to map the background features which can then be ignored by the localization system in order to remove potential outliers that may otherwise confuse the system in identifying the optical references. Finally, the two masked (concealed) optical references are unmasked to the optical sensor assembly and detected by the optical sensor assembly by comparing the detected features of the optical references with the background, the optical references can be clearly identified to the system despite the presence of outliers (the outliers may be additional optical references of other work spaces for other robots, for example.

In another embodiment, the identifying step 804 may involve detecting a plurality of potential optical references by the optical sensor assembly. The processor then ranks each potential optical reference according to a predetermined criteria, such as reflectivity, relative position to the mobile robot, size, shape, or any other detectable feature. The processor then selects two of the potential optical references as the identified optical references based on the criteria—for example, the processor may select the most intensely reflective references which are within the expected range of positions of the optical references in the predetermined shape.

After identifying the first two optical references, the method 800 proceeds to determining step 806, which involves determining, by a processor of the mobile robot, the width of the operating space based on the distance between the two identified optical references. The two optical references may form one axis of the coordinate system, for example. The method 800 then proceeds to searching step 808, which involves searching for and detecting, by the optical sensor assembly, the third optical reference, selected based on the relative angle of the location of the third reference with respect to the line formed by the two detected optical references. in this step 808, the robot may be instructed to rotate or move, by a predetermined angle or distance sufficient for the optical sensor assembly to detect at least the third optical reference, or may be instructed to rotate or move until the third optical reference is detected in a predefined search pattern. In some embodiments, the searching for and detecting step 808 may involve detecting and identifying one or more intermediary optical references which do not define the operating space (such as optical references 103 and 104 of FIG. 1, for example) and the third optical reference may additionally be selected based on an expected distance from the first and second optical references. The robot may record and use the positions of the intermediary optical optical references with respect to the first, second and third optical references for determining the position of the robot within the operating space, such as when one of the first, second, or third optical references cannot be detected due to field of view or obstruction, for example.

Finally, the initialization method 800 concludes with defining step 810, which involves defining, by the processor of the mobile robot, the length of the operating space as a perpendicular distance between the detected third optical reference and the straight line formed by joining the two detected optical references. The perpendicular direction of the perpendicular distance may form the orthogonal axis of the coordinate system, for example. With the robot localized and the operating space defined both lengthwise and widthwise, the initialization method 800 is now concluded and the robot may now operate in the operating space, using, for example, localization method 600 to localize itself during operation. The method 800 may then optionally include searching for and detecting further optical references, such as a fourth optical reference, which does not define the operating space. The further optical references can be used in place of the first, second, or third optical reference in determining the position of the robot within the operating space by knowing the relative position and angle of the further optical reference with respect to the first, second, and third optical references, such as when one of the first, second, or third optical references cannot be detected due to field of view or obstruction, for example.

In other embodiments, the operating space may not be a rectangular shape, but may be any polygonal shape. in such embodiments, the method of initialization can be used in a similar manner with respect to the first two optical references, and then detecting additional defining optical references in order to define the work field of the robot. The total number of defining optical references (including the first two optical references) is 3 for a n-sided regular polygon, and n for an n-sided irregular polygon. The expected angles of the vertices of the polygon should be predefined, and the robot searches for optical references along the predefined heading. For a regular polygon, the dimensions of the operating space can be defined by 3 optical references, extrapolating with the equal side lengths determined by the distance to the third optical reference. For an irregular polygon, each side length is defined by the distance from the previous optical reference to the next detected closest optical reference based on an expected angle dictated by the predefined heading.

The method for initializing a system for optical localization of an autonomous mobile robot 800 may be repeated with another set of optical references and/or predefined parameters to redefine or expand the operating space of the mobile robot, for example.

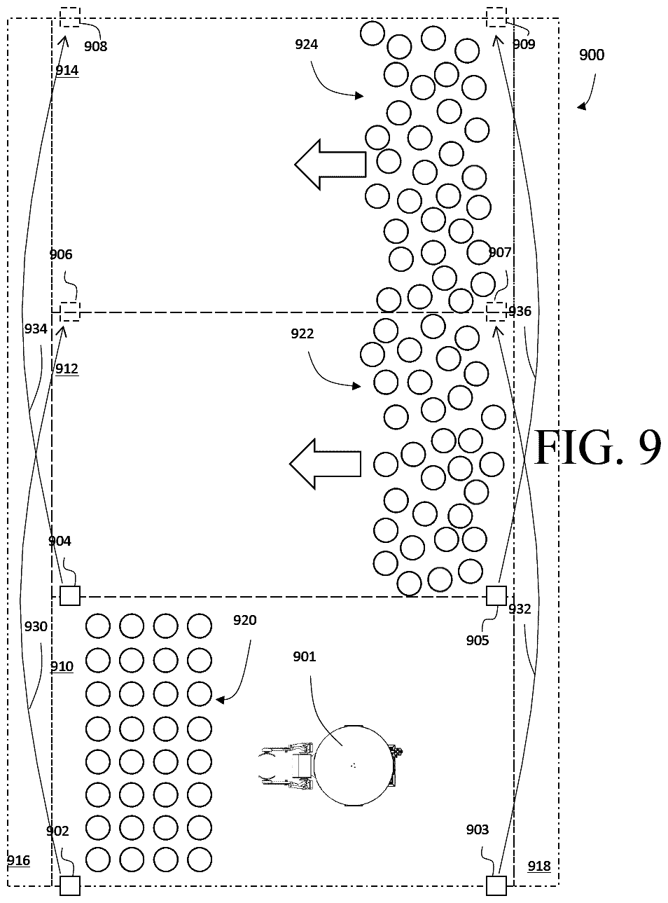

Referring to FIG. 9, this illustrates how the previously described system 100 of FIG. 1 may be refined to incorporate a method for expanding the operating space of the mobile robot. The system 900 includes a mobile robot 901 and four landmarks 902, 903, 904, and 905, which define an operating space 910 within which the robot 901 may carry out tasks, using the landmarks 902-905 for optical localization during carrying out the tasks. In the embodiment shown, the task may be moving articles 920 such as potted plants from one side of operating space 910 (such as near landmarks 903 and 905) to the opposite side (such as near landmarks 902 and 904), for example. In this embodiment, operating space 910 may be a single bay in a plant nursery, and there may be other bays adjacent to the operating space 910 such as additional bays 912 and 914. The bays 910, 912 and 914 may all be aligned and flanked by access pathways 916 and 918, which are generally kept free of obstacles. Additional bays 912 and 914 may each have corresponding sets of articles 922 and 924 such as pots which are to be moved to the opposite end of their respective bays and arranged in an orderly fashion. In this scenario, once the robot 901 has completed the initial task of moving and arranging articles 920 in the operating space 910, the robot is now idle.

Usually, an external agent such as a human operator must then manually move one or more of the landmarks 902-905 to new positions so as to define a new operating space, such as bay 912, and manually move the robot to bay 912. However, in the disclosed embodiment, the robot 901 recognizes that it has completed all available tasks assigned to it within operating space 910, and additionally has tasks in additional bays 912 and 914 assigned to it. Upon completion of the tasks in operating space 910, the mobile robot 901 then begins the process of moving the operating space 910 from its initial bay to bay 912. To move the operating space 910, the robot 901 moves landmark 902 to a first new position 906, and landmark 903 to a second new position 907. (Although not described in detail, the orientation of each repositioned landmark may also be taken into account when it is repositioned). New positions 906 and 907 are on the opposite side of, and substantially equally distant to, landmarks 904 and 905 compared to initial positions of landmarks 902 and 903. Ideally, the landmarks 902 and 903 are moved one at a time, with the robot 901 relying on the remaining three landmarks to remain “localized”. To the extent that the effective optical range between the mobile robot (more precisely, the optical sensor on the mobile robot) and the landmarks might be a relevant consideration, it may be preferable to move landmarks 902 and 903 across the positions of landmarks 904 and 905, so that the mobile robot 901 can move within a space where it remains within effective optical range of the localization system provided by the remaining three landmarks. For example, when the robot 901 is moving landmark 902, it first moves from operating space 910 into the adjacent bay 912, but staying relatively near landmarks 904 and 905 such that landmark 903 remains in effective optical range (to the extent that the optical range may be an issue). The robot 901 then moves into access pathway 916 and moves to pick up landmark 902. The robot 901 then moves landmark 902 to new position 906 following path 930. However, it is possible that when the robot 901 is moving along path 930, it may reach a point where landmark 903 is out of effective optical range of the robot. The robot 901 can still carry out navigation based on the two remaining landmarks 904 and 905. For example, while the landmark 903 may be out of effective optical range of the robot 901, the landmark 903 may still be in functional range of the robot 901. In such a case, the robot 901 may still be able to detect landmark 903, but the distance/relative angle information may be relatively less accurate. However, the robot 901 remains within effective optical range of landmarks 904 and 905 at all times and is able to accurately detect distance and relative angle information from these two landmarks. Thus, through triangulation or trilateration, the robot 901 can at least narrow down its position/orientation. When landmark 902 is placed in new position 906, the robot 901 may then navigate back to pick up landmark 903, using landmarks 902 (at 906), 904 and 905 when the robot 901 is in bay 912, and landmarks 903, 904 and 905 when it is in space 910, for example. When landmark 903 is picked up, the robot 901 again uses the accurate information from landmarks 904 and 905 coupled with possibly less accurate information from landmark 902 (at 906) to navigate along path 932, and place landmark 903 at new position 907. The operating space 910 is now redefined as bay 912, and the robot 901 can then carry out the task of moving and arranging articles 922 in bay 912 using the landmarks 904, 905, 902 (at 906), and 903 (at 907) for localization.

When the robot 901 has completed all tasks in the operating space 910 (now 912), it can repeat the process, this time moving landmarks 904 and 905 to new positions 908 and 909 along paths 934 and 936 respectively, redefining the operating space 910 as bay 914 in order to allow the robot 901 to move and arrange articles 924. In this manner, the robot 901 can effect horizontal operating space expansion as the robot 901 can continuously move into adjacent operating spaces to continue operation.

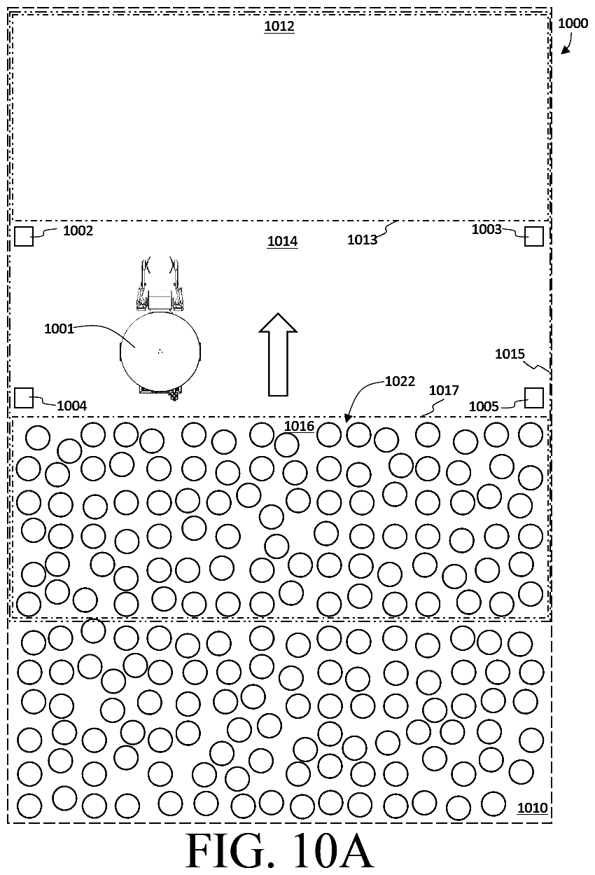

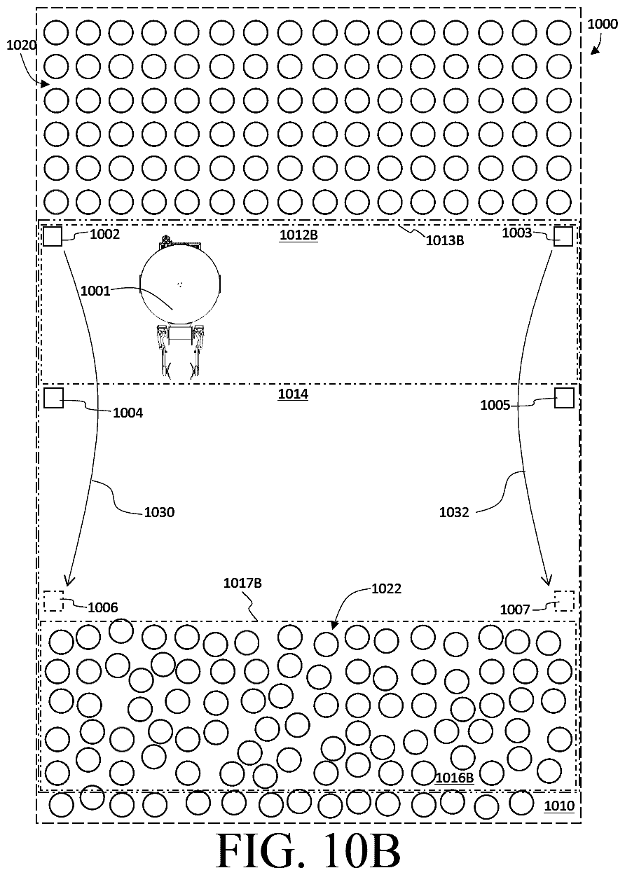

Referring to FIGS. 10A and 10B, an alternative system implementing a different method for expanding the operating space of a robot is shown generally at 1000. The system 1000 includes a mobile robot 1001 and four landmarks 1002, 1003, 1004, and 1005 located within a field 1010. The robot 1001 and landmarks 1002-1005 are similar to the landmarks 92-95 of FIG. 9.

As seen in FIG. 10A, to the extent that the effective optical range for the mobile robot may be an issue, the effective range of the mobile robot vis-a-vis the landmarks 1002-1005 determines an operating space 1014, defined by border line 1015. The operating space can be further divided into a drop-off area 1012, defined by border line 1013, and a pick-up area 1016, defined by border line 1017, on either side of the landmarks 1002-1005. In this embodiment, the robot 1001 is tasked with moving a plurality of articles 1022, such as potted plants, from the pick-up area 1016 to the drop-off area 1012. In such a case, it may be desirable for the robot 1001 to autonomously expand the operating space 1014 such that additional articles 1022 may be accessed, so that the robot 1001 may complete its task of moving articles 1022 entirely autonomously without the need for an external party such as a human operator to monitor and/or assist the robot 1001 in redefining its operating space 1014, for example.

Referring now to FIG. 10B, the robot 1001 has completed its initial task of moving and arranging articles 1020 placed into what was drop-off area 1012 of FIG. 10A, and what was pick-up area 1016 of FIG. 10A is now vacant. In order to access further articles 1022, the robot 1001 now proceeds to expand the operating space 1014 vertically, within the same field 1010. The robot 1001 first approaches landmark 1002, and then transports it along path 1030 to a new position 1006. The robot 1001 then repeats the process except with landmark 1003, transporting it along path 232 to a new position 1007. With the landmarks 1002-1005 now located at 1004, 1005, 1006, and 1007, the robot 1001 has now redefined the operating space 1014. The region which was previously empty between the landmarks 1002, 1003 and landmarks 1004, 1005 in FIG. 10A is now defined as new drop-off area 1012B by border line 1013B. The robot can now repeat the task of moving and arranging articles 1022 from new pick-up area 1016B to new drop-off area 1012B, placing them next to the previously-placed articles 1020.

The field 1010 may continue to extend for any length, and the robot 1001, by following this method, will be able to eventually access and move all articles 1022 in field 1010. For example, as seen in FIG. 10B, there is a single row of articles 1022 not included in new pick-up area 1012B. If the robot 1001 needs to also move these articles 1022, the robot 1001 may repeat the above procedure, instead moving landmarks 1004, 1005 to new positions adjacent to the last row, thereby again redefining new pick-up and drop-off areas, for example. If there are even more articles 1022, the robot 1001 may continuously repeat this process, by alternatively moving landmark sets 1002, 1003 and 1004, 1005 in a staggered manner to continuously redefine and effectively expand the operating space 1014 of the mobile robot 1001 to accommodate a vertically-extending field 1010 of any length.

Furthermore, the vertical operating space expansion of FIGS. 10A and 10B may be coupled with the horizontal operating space expansion of FIG. 9 if the adjacent fields follow a specific configuration. If adjacent fields or bays are arranged in alternating fashion with articles clustered at alternating opposite ends, the robot can expand the operating space vertically along a first field according to the system shown in FIGS. 10A and 10B, then expand the operating space horizontally into an adjacent field according to the system shown in FIG. 9 once it has reached the end, then expand the operating space vertically in the opposite direction for the second field, expanding horizontally again, and repeating to cover a field arrangement of any size.

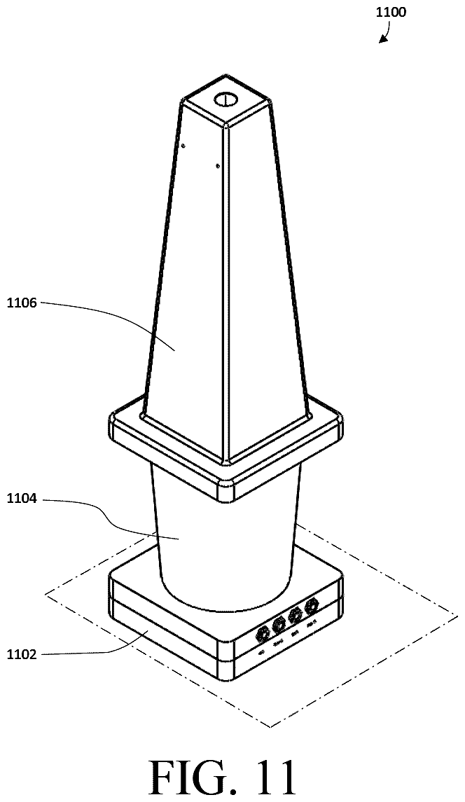

Referring to FIG. 11, an alternative embodiment of a robot-movable landmark is shown generally at 1100. (The landmark 1100 may also be a UWB-based beacon (originally intended for use in system relying on localization using UWB), that is co-opted and repurposed for use in the present optical localization system of the present invention). In this embodiment, the landmark 1100 may comprise a base 1102, a robot-interaction region 1104, and an elevated portion 1106. The base 1102 may optionally include various ports such as power and signal interfaces for charging or configuring the landmark. The landmark 1100 or the base 1102 may also include indicator lights for displaying the status of the landmark. The robot-interaction region 1104 preferably has a substantially similar shape to the articles, such that the robot can easily interact with the landmark 1100 using the same end effector of a manipulator that is used to interact with articles. In the disclosed embodiment, the articles may be cylindrical pots, and the landmark 1100 has a cylindrical robot-interaction region 1104 of similar dimensions to the pots (articles), such that the robot can easily interact with and transport the landmark 1100. The elevated portion 1106 extends above the robot-interaction region 1104. The additional height provided by the elevated portion 1106 may provide clearance over the articles and assists in providing an unobstructed line of sight with the raised optical sensor of the mobile robot. The elevated portion 1106 comprises one or more of: a characteristic cross-sectional geometry feature; a visually distinct portion; and a unique identified (as previously shown and described in FIG. 3, but which are not specifically depicted here so as not to obscure other details). The elevated portion 1106 may also provide other functionality, such as assisting human operators in identifying the operating space, for example.

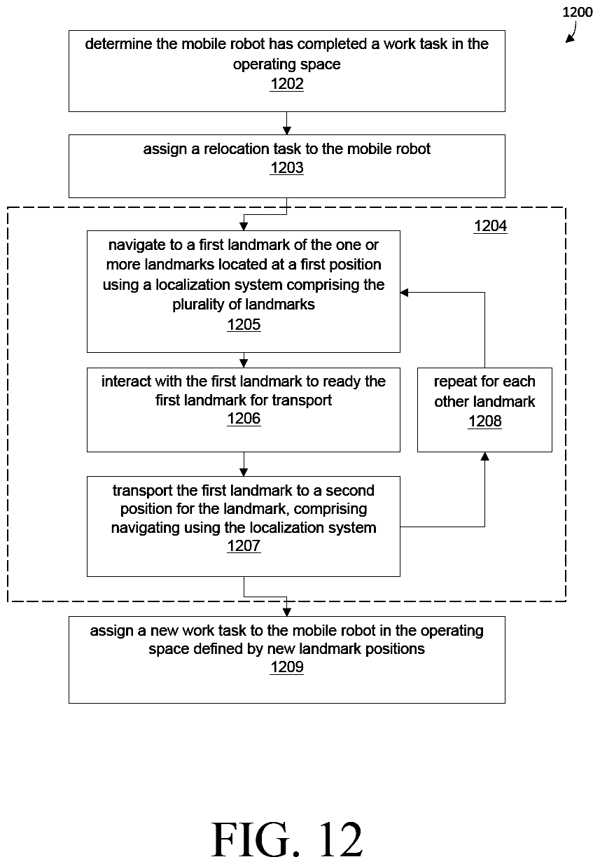

Referring to FIG. 12, a method for expanding the operating space of a robot is shown generally at 1200. The method includes a determining step 1202, an assigning step 1203, and executing step 1204 and a second assigning step 1209. In the determining step 1202, a processing unit determines that the mobile robot has completed a work task in a current operating space. The work task may be the last task assigned to the robot such that there are no further tasks to do in the operating space, and the robot may become idle without additional tasks assigned. In the assigning step 1203, the processing unit assigns a relocation task to the mobile robot. In the executing step 1204, the mobile robot executes the relocation task, the relocation task including a navigating step 1205, and interacting step 1206, a transporting step 1207, and a repeating step 1208. The executing step 1204 begins with the navigating step 1205, which involves the mobile robot navigating to a first landmark of the one or more landmarks located at a first position using a localization system comprising the plurality of landmarks. The executing step 1204 then proceeds to the interacting step 1206 where the mobile robot interacts with the first landmark to ready the first landmark for transport, such as engaging the first landmark with the end effector of a manipulator on the mobile robot, for example. The executing step 1204 then involves transporting the first landmark to a second position for the landmark by the mobile robot, including navigating the mobile robot using the localization system, in the transporting step 1207. If there are still other landmarks in the one or more landmarks to be moved, the executing step 1204 then proceeds to the repeating step 1208, which involves repeating the steps of the executing step 1204 starting from the navigating step 1205 for each other landmark of the one or more landmarks to be moved. If all the landmarks have been moved, the method 1200 instead proceeds to the assigning step 1209, where the processing unit assigns a new work task to the mobile robot in the operating space defined by new landmark positions.

While specific embodiments have been described and illustrated, such embodiments should be considered illustrative of the invention only and not as limiting the invention as construed in accordance with the accompanying claims.

1. A system for optical localization, the system comprising;
a plurality of movable stationary landmarks defining an operating space; and
an autonomous mobile robot located in the operating space, the mobile robot comprising:
a self-propelled mobile chassis;
an optical sensor assembly disposed on a raised portion vertically spaced apart from the chassis, configured to optically detect at least one of the plurality of landmarks; and
a controller configured to determine the position and orientation of the chassis based at least on information from the optical sensor assembly.

2. The system of claim 1, wherein the optical sensor assembly comprises a LiDAR sensor or an optical camera.

3. The system of claim 1, wherein each landmark of the plurality of landmarks comprises an elevated portion extending vertically to a height level which is equal to or higher than a horizontal plane that extends from the optical sensor assembly of the mobile robot, wherein the elevated portion is optically detectable by the optical sensor assembly.

4. The system of claim 1, wherein each landmark of the plurality of landmarks comprises one or more of:
a characteristic cross-sectional feature for determining orientation relative to the landmark;
a characteristic visually distinct portion for determining orientation relative to the landmark; and
an identifier uniquely identifying the landmark from other landmarks.

5. The system of claim 1, wherein the optical sensor assembly is mounted on an actuated column vertically movable between an extended portion where the optical sensor assembly is vertically spaced apart from the chassis and a retracted position where the optical sensor assembly is held relatively near the ground.

6. A method for optical sensor-based localization of an autonomous mobile robot, the method comprising:
detecting, by an optical sensor assembly located on the mobile robot, a detected optical reference;
determining, by a processing unit, based on the detected optical reference:
a detected distance to the detected optical reference;
a detected relative angle to the detected optical reference; and
a detected orientation of the detected optical reference; and
calculating, by the processing unit, a position and an orientation of the mobile robot based on the detected distance, detected orientation, and detected relative angle of the detected optical reference, using a known relationship between the mobile robot, the optical sensor assembly and the detected optical reference.

7. The method of claim 6 further comprising:
either moving the detected optical reference, while keeping the sensor assembly stationary, or moving the sensor assembly, while keeping the detected optical reference stationary;
tracking, by the processing unit, the relative movement of the detected optical reference to the sensor assembly and information on which one of the detected optical reference or sensor assembly moved; and
determining, by the processing unit, a new position and orientation of the mobile robot based on the detected distance and detected relative angle of the detected optical reference using a known relationship between the mobile robot, the optical sensor assembly, and the detected optical reference, the tracked relative movement of the optical reference and the sensor assembly, and the information on which one of the detected optical reference or sensor assembly moved.

8. The method of claim 6, wherein the known relationship is either a static relationship defined at initialization, or a dynamic relationship which changes during operation of the mobile robot and is communicated to the processing unit.

9. A method for optical sensor-based localization of an autonomous mobile robot during operation of the mobile robot, the method comprising:
when the mobile robot is located in a first position, detecting, by an optical sensor assembly located on the mobile robot, a first detected optical reference and a second detected optical reference;
determining, by a processor, based on the first and second detected optical references:
a detected first distance to the first detected optical reference and a detected second distance to the second detected optical reference; and
a detected first relative angle to the first detected optical reference and a detected second relative angle to the second detected optical reference;
calculating, by the processor, a position and an orientation of the mobile robot based on the detected first distance, the detected second distance, the detected first relative angle, and the detected second relative angle;
detecting, by the optical sensor assembly, at least one further optical reference;
calculating, by the processor, a position of the at least one further optical reference with respect to the first and second detected optical references;
moving the mobile robot, from the first position to a second position;
detecting, by the optical sensor assembly, at least two of: the first detected optical reference, the second detected optical reference and the at least one further optical reference; and
calculating, by the processor, the orientation and position of the mobile robot based on the detected distances and detected relative angles of any two of: the first detected optical reference, the second detected optical reference and the at least one further detected optical reference.

10. The method of claim 9, further comprising establishing, by the processor, a global coordinate system based on each of the detected optical references.

11. The method of claim 10, further comprising:
detecting, by a second sensor of the mobile robot, at least one object;
calculating, by the processor, a position of the detected at least one object with respect to the detected optical references by:
determining, by the processor, the relative position of the second sensor to the mobile robot;
determining, by the second sensor, a position of the at least one objects relative to the robot; and
transforming, by the processor, the position of the at least one object relative to the second sensor to the global coordinate system; and
storing, by the processor, the calculated position of each of the at least one objects with respect to the global coordinate system in a memory.

12. The method of claim 9, further comprising:
storing, by the processor, the relative positions of each of the first detected optical reference, the second optical reference and the at least one further detected optical reference in a memory; and
determining, by the processor, the identity of features detected by the optical sensor assembly as optical references based on at least the stored relative positions of the optical references stored in the memory.

13. The method of claim 9 further comprising:
detecting, by the optical sensor assembly, an optical feature of a second mobile robot;
determining, by the processor, based on the detected optical feature:
a distance to the second mobile robot; and
an orientation of the second mobile robot; and
calculating, by the processor, a position and an orientation of the second mobile robot relative to the detected optical references based on the detected distances and detected relative angles of the optical feature.

14. The method of claim 13, further comprising:
communicating, by the processor of the mobile robot through a communication device on the mobile robot, with a processor of the second mobile robot through a communication device on the second mobile robot; and
transmitting, by the processor of the mobile robot, the orientation and position of the second mobile robot relative to the detected optical references.

15.-18. (canceled)
